(19) United States
(12) Patent Application Publication
(10) Pub. No.: US 2011/0158697 A1
(43) Pub. Date: Jun. 30, 2011

(54) Developer bearing member, developing device, and image forming apparatus

(75) Inventors: Naoya Iwata, Yokohama (JP); Kenji Tanaka, Yokohama (JP)

(73) Assignee: SAMSUNG ELECTRONICS CO., LTD., Suwon (KR)

(21) Appl. No.: 12/926,982

(22) Filed: Dec. 21, 2010

(30) Foreign Application Priority Data
Dec. 25, 2009 (JP) 2009-295938
Oct. 19, 2010 (KR) 10-2010-0101882

(51) Int. Cl. G03G 15/08

(52) U.S. Cl. 399/254; 399/286

(57) ABSTRACT

A developer bearing member that carries a developer including a carrier and a toner on its outer circumferential surface, and transports the developer, wherein a plurality of grooves having a V-shape extending in an axial direction are formed on the outer circumferential surface of the developer bearing member, and wherein an edge at which the outer circumferential surface of the developer bearing member meets an inner sidewall forming each of the plurality of grooves is removed.

### CROSS-REFERENCE TO RELATED APPLICATIONS

This application claims the benefit of Japanese Patent Application No. 2009-295938, filed on Dec. 25, 2009, in the Japanese Patent Office, and Korean Patent Application No. 10-2010-0101882, filed on Oct. 19, 2010, in the Korean Intellectual Property Office, the disclosures of which are incorporated herein in their entirety by reference.

### BACKGROUND

1. Field

The present general inventive concept relates to an electrophotographic or electrostatic recording image forming apparatus, and a developing device, and more particularly, to a developing roller used in a developing device that develops an electrostatic latent image on an image bearing member by using a two-component developer.

2. Description of the Related Art

In a developing roller that is a developer bearing member according to the related art, a surface of a developing sleeve is rough so as to improve developer transportability. For example, the surface of the developing sleeve is rough by performing a blast treatment, or mesh-shaped grooves are formed on the surface of the developing sleeve via a roulette processing. However, the developing sleeve after the blast treatment is easily worn during use so that durability of the developing sleeve after the blast treatment deteriorates. In addition, although the developing sleeve after the roulette processing has great durability, a processing time and processing work increase, such that a thin developing sleeve may easily deform while being processed.

Thus, in general, a plurality of grooves extending in an axial direction of a developing sleeve are formed at regular intervals on an outer surface of the developing sleeve. In a case where the developing sleeve is used, developer transportability is significantly improved, but the developing sleeve is formed of a relatively soft metal so as to increase accuracy in a processing operation. Thus, when a lifetime of the developing device comes close to an end, the developer transportability deteriorates such that image inferiority occurs. Also, when the developer transportability is improved, a gap for the arrangement of a thickness regulating member facing the developing sleeve is narrowed, such that the gap is filled with foreign substances.

In order to solve these problems, Japanese Patent Publication No. 2000-321864 discloses a developing sleeve having a V-shaped groove extending in an axial direction of the developing sleeve, wherein an inclination angle of the V-shaped groove at an upstream side in a developer transporting direction is greater than an inclination angle of the V-shaped groove at a downstream side, so as to achieve stability in developer transportability. Also, Japanese Patent Publication No. 2004-021043 discloses a developing sleeve having a V-shaped groove extending in an axial direction of the developing sleeve, wherein an inclination angle of the V-shaped groove at an upstream side in a developer transporting direction is less than an inclination angle of the V-shaped groove at a downstream side, so as to prevent a developer from sticking in the V-shaped groove formed in the developing sleeve.

However, according to Japanese Patent Publication No. 2000-321864, the V-shaped groove of the developing sleeve is right-and-left asymmetrical, such that it is necessary to define an assembling direction of the developing sleeve when the developing sleeve is distributed or assembled, which may increase costs due to a rise of unnecessary managing costs, and quality may be affected due to an inappropriate assembly. Also, since an angle of the V-shaped groove at the upstream side in the developer transporting direction is greater than an angle of the V-shaped groove at the downstream side, a toner easily attaches in the V-shaped groove and then the attached toner is fixed, thereby deteriorating developer transportability. Furthermore, the V-shape of the groove of the developing sleeve easily accepts the developer such that a load on an edge part of the V-shaped groove increases, this increased load leads to deformation of the edge part of the V-shaped groove, and deterioration in the developer transportability.

According to Japanese Patent Publication No. 2004-021043, the V-shaped groove of the developing sleeve is also right-and-left asymmetrical, such that, as described in relation to Japanese Patent Publication No. 2000-321864, costs may increase due to a rise of unnecessary managing costs, and quality may be affected due to an inappropriate assembly. Since an angle of the V-shaped groove at the downstream side in the developer transporting direction is greater than an angle of the V-shaped groove at the upstream side, it may be possible to temporarily prevent the developer from sticking in the V-shaped groove formed in the developing sleeve. However, developer transportability by the V-shaped groove highly affects a shape of a V-shaped edge part (a part at which an outer circumferential surface of the developer sleeve meets an inner sidewall of the V-shaped groove), so that an edge part at the downstream side becomes round, thus, the developer transportability sharply deteriorates. The deterioration of the developer transportability highly effects sharp decrease of an image density, thereby deteriorating an image quality.

A method of forming a plurality of grooves extending in an axial direction on a surface of a developing sleeve may deteriorate maintenance and transportability with respect to a developer due to the fact that a flat portion between grooves causes a slip of the developer in the flat portion. With regards this problem, Japanese Patent Publication No. 05-025459 discloses a developing sleeve whereon a plurality of V-shaped grooves extending in an axial direction are formed, and a blast treatment is performed on a flat portion between the adjacent V-shaped grooves. The developing sleeve is excellent in wear-resistance and groove workability, and does not cause a slip of a developer in the flat portion between the adjacent V-shaped grooves, so that the developing sleeve can stably transport the developer. However, developer maintenance on a surface of the developing sleeve is too great, and a gap for the arrangement of a thickness regulating member facing the developing sleeve is narrowed, such that the gap is filled with foreign substances.

### SUMMARY

The present general inventive concept provides a developer bearing member, a developing device, and an image forming apparatus, whereby a developer is stably transported and maintained.

According to an aspect, there is provided a developer bearing member that carries a developer including a carrier and a toner on its outer circumferential surface, and transports the developer, wherein a plurality of grooves having a V-shape extending in an axial direction are formed on the outer circumferential surface of the developer bearing member, and wherein an edge at which the outer circumferential surface of the developer bearing member meets an inner sidewall forming each of the plurality of grooves is removed.

When a lowest point of each of the plurality of grooves is referred to as a point P0, a straight line connecting the point P0 and a rotational center of the developer bearing member is referred to as a virtual line L, a random point on an inner sidewall forming the V-shape of each of the plurality of grooves is referred to as a point P1, a random point on the outer circumferential surface of the developer bearing member is referred to as a point P2, a cross point between the virtual line L and a line extending from the point P1 in a perpendicular direction with respect to the virtual line L is referred to as a point P3, a depth of each of the plurality of grooves is referred to as d1, a distance between the point P3 and the point P0 is referred to as d2, a diameter of a carrier is referred to as d3, an angle between the virtual line L and a straight line connecting the point P0 and the point P1 is referred to as θ1, and an angle between the virtual line L and a straight line connecting the point P2 and the point P1 is referred to as θ2, each of the plurality of grooves of the developer bearing member may satisfy at least one or all of relations ‘θ1<θ2’, ‘d3/3<d1−d2<d3’, and ‘d1>d3×2’.

Each of the plurality of grooves may be symmetrical with respect to the virtual line L.

According to another aspect, there is provided a developing device including an agitating and transporting unit containing a developer including a carrier and a toner, the agitating and transporting unit including agitating and transporting members that mix and agitate the developer, and then transport the developer in a predetermined transporting direction; and the above-mentioned developer bearing member, wherein the developer bearing member is arranged facing an electrostatic latent image bearing member bearing an electrostatic latent image, carries the developer agitated and mixed by the agitating and transporting unit on its outer circumferential surface, and then transports the developer to the electrostatic latent image bearing member.

According to another aspect, there is provided an image forming apparatus including an electrostatic latent image bearing member bearing an electrostatic latent image on its outer circumferential surface; and the above-mentioned developing device developing the electrostatic latent image on the electrostatic latent image bearing member.

### BRIEF DESCRIPTION OF THE DRAWINGS

The above and other features and advantages will become more apparent by describing in detail exemplary embodiments thereof with reference to the attached drawings in which:

FIG. 1 is a schematic view showing the configuration of an image forming apparatus according to an embodiment;

FIG. 2 is a diagram showing the configuration of a developing device according to the embodiment;

FIG. 3 is a diagram showing an example of one a plurality of grooves formed in the developing sleeve;

FIG. 4 is a diagram showing a status of a developer transported by the groove of the developing sleeve;

FIG. 5 is a graph showing a developer transportation function with respect to use time;

FIG. 6 is a graph showing the relationship between an amount of developer and a gap between a developing sleeve and a thickness regulating member, with respect to a developing sleeve according to the related art and the developing sleeve according to an embodiment; and

FIG. 7 is a diagram showing another example of a groove formed in the developing sleeve.

### DETAILED DESCRIPTION

The present general inventive concept will now be described more fully with reference to the accompanying drawings, in which exemplary embodiments of the present general inventive concept are shown. Like reference numerals in the drawings denote like elements, and thus their description will be omitted

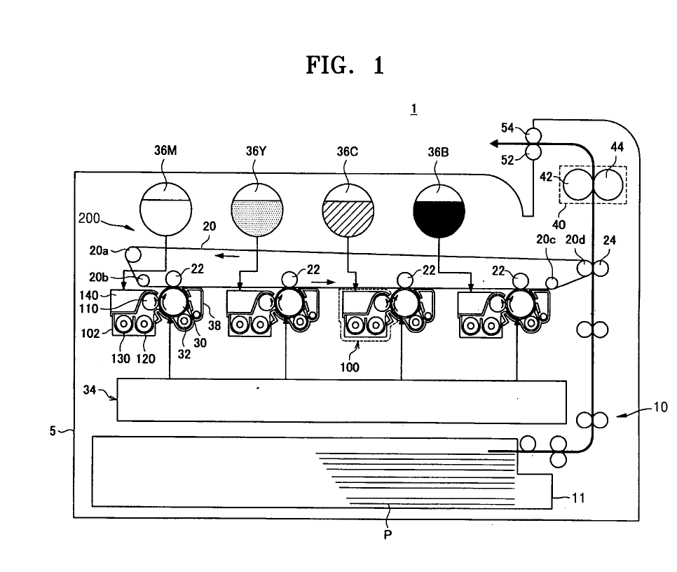

FIG. 1 is a schematic view showing the configuration of an image forming apparatus 1 according to an embodiment. Referring to FIG. 1, the configuration of the image forming apparatus 1, including a developing device 100, will be described.

### <1. Configuration of Image Forming Apparatus>

The developing device 100 may be included in a tandem-type image forming apparatus as illustrated in FIG. 1. As illustrated in FIG. 1, the image forming apparatus 1 includes a recording medium transporting unit 10, a transfer unit 200 including a transfer belt 20 as an intermediate transfer body, a photoconductive drum 30 for bearing an electrostatic latent image, the developing device 100 for developing the electrostatic latent image formed on the photoconductive drum 30, and a fixing unit 40.

The recording medium transporting unit 10 accepts a recording medium whereon an image is finally formed, and simultaneously transports the recording medium in a recording medium transportation path. The recording medium may be a paper P, and may be stacked in a cassette unit 11. The recording medium transporting unit 10 transports the paper P to a second transfer area to match the time when a toner image to be transferred to the paper P is formed and transported to the second transfer area.

The transfer unit 200 transports the toner image formed by the developing device 100 to the second transfer area in which the toner image is second-transferred to the recording medium. The transfer unit 200 includes the transfer belt 20, suspension rollers 20a, 20b, 20c, and 20d for supporting the transfer belt 20, first transfer rollers 22 for performing a holding operation together with the photoconductive drum 30 so as to hold the transfer belt 20, and a second transfer roller 24 for performing a holding operation together with the suspension roller 20d so as to hold the transfer belt 20.

The transfer belt 20 is a seamless belt that is rotated by the suspension rollers 20a, 20b, 20c, and 20d. The first transfer rollers 22 are arranged on an inner surface of the transfer belt 20 so as to press the photoconductive drum 30. The second transfer roller 24 is arranged on an outer surface of the transfer belt 20 so as to press the suspension roller 20d. Although not illustrated in FIG. 1, the transfer unit 200 may further include a belt cleaning member for removing a toner attached to the transfer belt 20.

The photoconductive drum 30 is an electrostatic latent image bearing member, and an image is formed on an outer circumferential surface of the photoconductive drum 30. For example, the photoconductive drum 30 is formed of an organic photoconductor (OPC). The image forming apparatus 1 may form a color image, and may include the four photoconductive drums 30 that correspond to magenta, yellow, cyan, and black colors, respectively, and that are arranged in a rotation direction of the transfer belt 20. As illustrated in FIG. 1, a charging roller 32, an exposing unit 34, the developing device 100, and a cleaning unit 38 are arranged in the vicinity of each of the four photoconductive drums 30.

The charging roller 32 charges a surface of the photoconductive drum 30 to a uniform electric potential. The exposing unit 34 exposes the surface of the photoconductive drum 30 charged by the charging roller 32 according to a target image. By doing so, an electric potential of a portion of the surface of the photoconductive drum 30 exposed by the exposing unit 34 is changed so that an electrostatic latent image is formed. The developing device 100 forms a toner image by developing the electrostatic latent image formed on the photoconductive drum 30 by using a toner supplied from toner tanks 36M, 36Y, 36C, and 36B. A detailed configuration of the developing device 100 will be described later.

After the toner image formed on the photoconductive drum 30 is first-transferred to the transfer belt 20, the cleaning unit 38 collects a toner that remained on the photoconductive drum 30. The cleaning unit 38 may remove the remaining toner from the outer circumferential surface of the photoconductive drum 30 by contacting a cleaning blade on the outer circumferential surface of the photoconductive drum 30. Also, in the vicinity of the photoconductive drum 30, a charge removal lamp (not shown) for resetting an electric potential of the photoconductive drum 30 may be arranged between the cleaning unit 38 and the charging roller 32 with respect to a rotation direction of the photoconductive drum 30.

The fixing unit 40 attaches the toner image, which is second-transferred from the transfer belt 20 to the recording medium, to the recording medium and then fixes it. The fixing unit 40 may include a heating roller 42 and a pressing roller 44. The heating roller 42 is a rotatable cylindrical shape member in which a heat source such as a halogen lamp is arranged. The pressing roller 44 is a rotatable cylindrical shape member arranged to press the heating roller 42. A heat-resistant elastic layer formed of a silicon rubber may be arranged around an outer circumferential surface of each of the heating roller 42 and the pressing roller 44. The recording medium passes through a fixing nip that is a contact area between the heating roller 42 and the pressing roller 44, so that the toner image is hot-melt fixed to the recording medium.

The image forming apparatus 1 includes discharge rollers 52 and 54 so as to externally discharge the recording medium whereon the toner image is fixed by the fixing unit 40.

When a control unit (not shown) of the image forming apparatus 1 receives an image signal about an image to be printed, the control unit controls the image forming apparatus 1 in such a manner that the surface of the photoconductive drum 30 is charged to a uniform electric potential by the charging roller 32, and then a laser beam is irradiated on the surface of the photoconductive drum 30 by the exposing unit 34 according to the received image signal so as to form an electrostatic latent image.

In the developing device 100, a toner and a carrier are mixed and agitated, and then are sufficiently charged. A charged developer is carried in a developing roller 110. When the developer is transported to an area facing the photoconductive drum 30 due to rotation of the developing roller 110, the toner in the developer carried in the developing roller 110 moves and develops the electrostatic latent image formed on the outer circumferential surface of the photoconductive drum 30. By doing so, the toner image is formed and then is first-transferred from the photoconductive drum 30 to the transfer belt 20 in an area where the photoconductive drum 30 and the transfer belt 20 face each other. Toner images formed on the four photoconductive drums 30 are sequentially stacked on the transfer belt 20, so that a stacked toner image is formed on the transfer belt 20. The stacked toner image is second-transferred to the recording medium transported by the recording medium transporting unit 10 in an interface between the suspension roller 20d and the second transfer roller 24.

The recording medium whereon the stacked toner image is second-transferred is transported to the fixing unit 40. The recording medium passes through the contact area between the heating roller 42 and the pressing roller 44 while heat and pressure are applied to the recording medium, so that the stacked toner image is hot-melt fixed to the recording medium. Afterward, the recording medium is externally discharged from the image forming apparatus 1 by using the discharge rollers 52 and 54. In a case where a belt cleaning member is arranged in the transfer belt 20, a toner that remained on the transfer belt 20 is removed by the belt cleaning member after the stacked toner image is second-transferred to the recording medium.

The tandem-type image forming apparatus 1 of FIG. 1 is an example of an image forming apparatus including the developing device 100, which may be used in various types of image forming apparatuses.

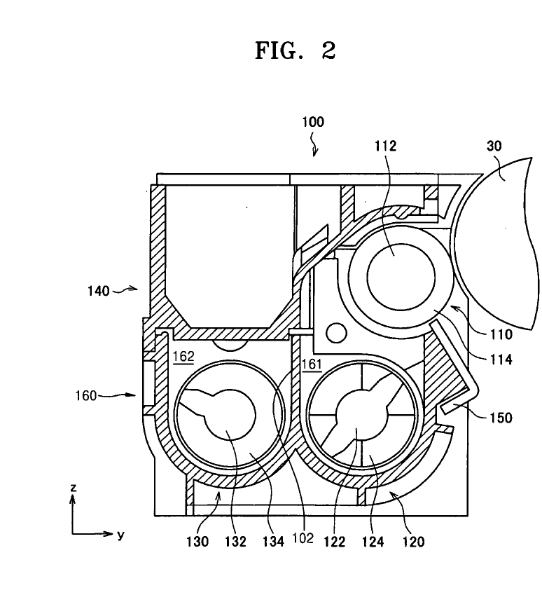

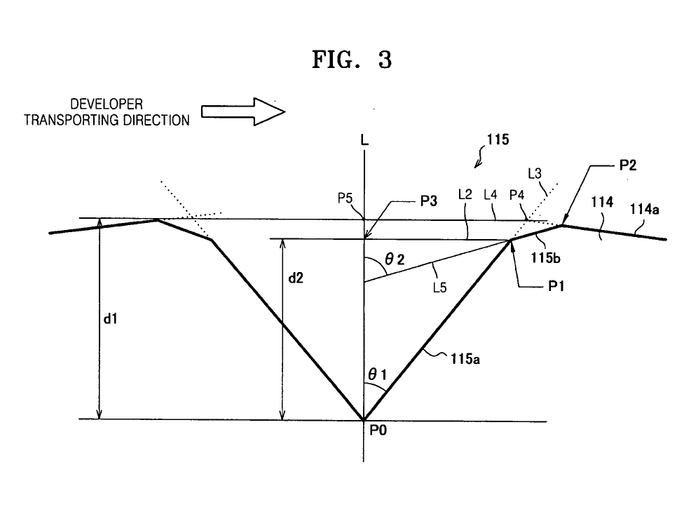

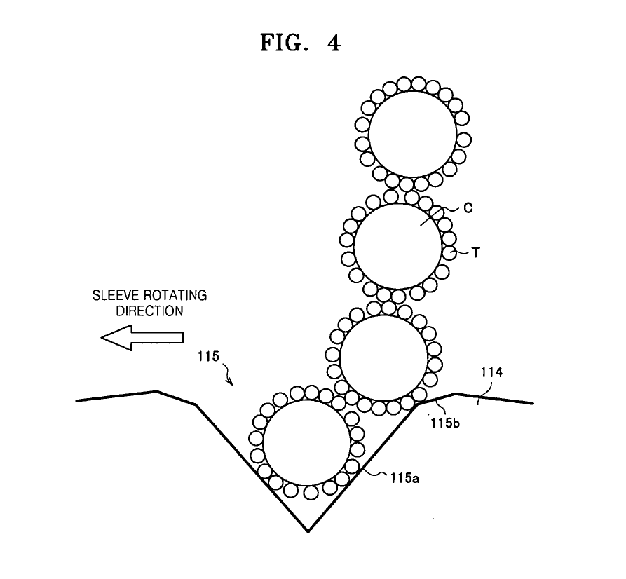

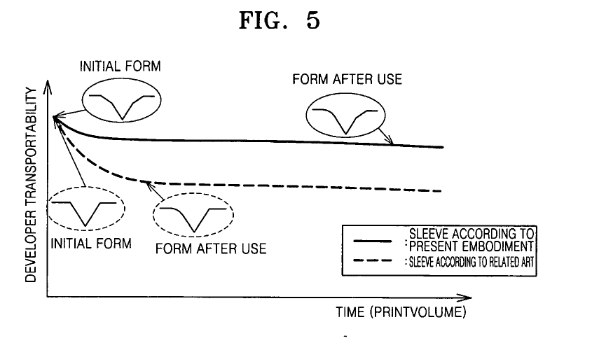

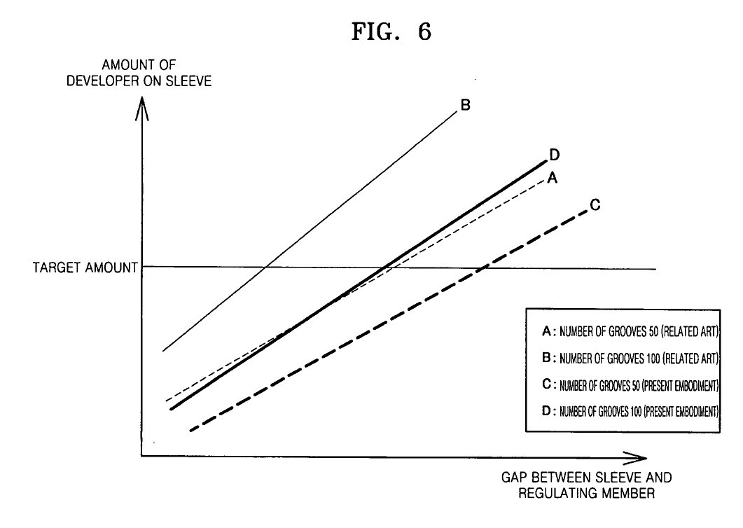

In the above, the configuration of the image forming apparatus 1 including the developing device 100 is described. The developing device 100 according to the present embodiment is characterized in including the developing roller 110 having stable transportability and maintenance of the developer. Hereinafter, with reference to FIGS. 2 through 6, a configuration of the developing device 100 and a configuration of a developing sleeve 114 will be described. FIG. 2 is a diagram showing the configuration of the developing device 100 according to the embodiment. FIG. 3 is a diagram showing an example of one of a plurality of grooves 115 formed in the developing sleeve 114. FIG. 4 is a diagram showing a status of a developer transported by the groove 115 of the developing sleeve 114. FIG. 5 is a graph showing a developer transportation function with respect to use time. FIG. 6 is a graph showing the relationship between an amount of developer and a gap between a developing sleeve and a thickness regulating member, with respect to a developing sleeve according to the related art and the developing sleeve 114 according to an embodiment.

### <2. Configuration of Developing Device>

As illustrated in FIG. 2, the developing device 100 includes the developing roller 110, and first and second agitating and transporting members 120 and 130.

The developing roller 110 is a developer bearing member that supplies a toner to an electrostatic latent image formed on the outer circumferential surface of the photoconductive drum 30. The developing roller 110 includes the developing sleeve 114 and a magnet 112 arranged in the developing sleeve 114. The developing sleeve 114 is a cylindrical shape member formed of a non-magnetic metal. The plurality of grooves 115 having a V-shape (refer to FIG. 3) extending in an axial direction are formed in a surface of the developing sleeve 114. A detailed form of the grooves 115 will be described later. In the developing roller 110 according to the present embodiment, only the developing sleeve 114 rotates, and the magnet 112 arranged in the developing sleeve 114 is fixed to a case 5. In addition, a developing bias voltage applying unit (not shown) is arranged so as to apply a developing bias voltage to the developing roller 110.

The magnet 112 may have a plurality of magnetic poles. For example, different magnetic poles may be alternately disposed in an area where the developing roller 110 and the photoconductive drum 30 face each other, that is, the different magnetic poles may be alternately disposed from a development area in which an electrostatic latent image formed on the photoconductive drum 30 is developed to a point at which the developing roller 110 and the agitating and transporting member 120 face each other. This is because a magnetic force transports a developer on the developing sleeve 114. Also, a pole position or a pole gap may be arranged in the development area, so that magnetic brushes of the developer rise to contact or approach the electrostatic latent image on the photoconductive drum 30. The pole position indicates that a magnetic pole is arranged in the development area. Also, the pole gap indicates that the development area is positioned between two magnetic poles.

Also, magnetic poles having the same polarity are disposed to be adjacent to each other in a circumferential direction on an area where the developing roller 110 faces the first agitating and transporting member 120. Due to the magnetic poles having the same polarity, a magnetic force in a normal line direction and a magnetic force in a tangential direction, with respect to a rotation direction of the developing sleeve 114, decrease in a pole gap. Thus, the developer is detached from the developing sleeve 114 at a position where the developing roller 110 and the first agitating and transporting member 120 face each other due to rotation of the developing sleeve 114.

Furthermore, a thickness regulating member 150 is arranged in an upstream side of a rotational direction of the developing sleeve 114 with respect to a position at which the developing sleeve 114 of the developing roller 110 and the photoconductive drum 30 face each other. The thickness regulating member 150 functions to regulate the developer to form a uniform thickness layer, wherein the developer is attached to an outer circumferential surface of the developing sleeve 114. The thickness regulating member 150 may include a metal blade.

An agitating and transporting unit 160 functions to charge a carrier and a toner by agitating the carrier that is a magnetic material and the toner that is a non-magnetic or soft-magnetic material, wherein the carrier and the toner form the developer. The agitating and transporting unit 160 includes the first agitating and transporting member 120 and the second agitating and transporting member 130.

The first agitating and transporting member 120 is arranged facing the developing roller 110 in a vertical direction, and supplies the mixed and agitated developer to the developing roller 110. The first agitating and transporting member 120 includes a first supporting shaft 122 and a first agitating wing 124. The first supporting shaft 122 is rotatably arranged by inserting a bearing into an inner wall of the case 5 or into a sidewall of the developing device 100. The first agitating wing 124 is arranged on an outer circumferential surface of the first supporting shaft 122, and includes a spiral slope disposed lengthwise to the first supporting shaft 122.

The second agitating and transporting member 130 functions to sufficiently charge the developer by mixing and agitating the developer, and to transport the charged developer to the first agitating and transporting member 120. Similar to the first agitating and transporting member 120, the second agitating and transporting member 130 includes a second supporting shaft 132 and a second agitating wing 134. For example, the second supporting shaft 132 is rotatably arranged by inserting a bearing into an inner wall of the case 5 or into a sidewall of the developing device 100. The second agitating wing 134 is arranged on an outer circumferential surface of the second supporting shaft 132, and includes a spiral slope disposed lengthwise to the second supporting shaft 132.

The first agitating and transporting member 120 and the second agitating and transporting member 130 are arranged such that the first supporting shaft 122 and the second supporting shaft 132 are approximately parallel with each other, for example, the first agitating and transporting member 120 and the second agitating and transporting member 130 are arranged horizontally in parallel (in a direction crossing a direction in which the developing roller 110 and the first agitating and transporting member 120 are adjacent to each other). A boundary wall 102 is arranged between the first agitating and transporting member 120 and the second agitating and transporting member 130. The boundary wall 102 is arranged in such a manner that the first agitating and transporting member 120 and the second agitating and transporting member 130 communicate with each other at respective ends. That is, the boundary wall 102 is arranged to be separate from a sidewall of the developing device 100, and an area 161 in which the first agitating and transporting member 120 is arranged and an area 162 in which the second agitating and transporting member 130 are arranged to communicate with each other via a gap between the boundary wall 102 and the sidewall of the developing device 100.

The developer that has been agitated and transported by the second agitating and transporting member 130 is delivered to an outer circumferential surface of the developing roller 110 while the developer is agitated and transported by the first agitating and transporting member 120. A toner density sensor (not shown) for detecting toner density may be arranged in the area 162 in which the second agitating and transporting member 130 is arranged. When the toner density decreases, a developer is supplied from a toner tank 36 to the agitating and transporting unit 160 via a developer supplying unit 140.

### <3. Configuration of Developing Sleeve>

The developing sleeve 114 including the plurality of grooves 115 having a V-shape and extending in an axial direction are formed to maintain a developer in the grooves 115 and to transport the developer. During use, an edge of the groove 115 becomes round, so that developer transportability of developing sleeve 114 deteriorates. That is, the edge of the groove 115 of the developing sleeve 114 highly contributes to the developer transportability. In order to stably transport and maintain the developer, an edge of a groove having a V-shape formed in a surface of the developing sleeve 114 is removed while satisfying conditions as stated below.

First, as illustrated in FIG. 3, a lowest point of the V-shaped groove 115 formed in the developing sleeve 114 is referred to as a point P0, and a straight line connecting the point P0 and a rotational center of the developing sleeve 114 is referred to as a virtual line L. Also, a random point on an inner sidewall 115a forming the V-shape of the groove 115 is referred to as a point P1, a random point on an outer circumferential surface 114a of the developing sleeve 114 is referred to as a point P2, and a cross point between the virtual line L and a line L2 that extends from the point P1 in a perpendicular direction with respect to the virtual line L is referred to as a point P3. Here, a depth of the groove 115 (which is a distance between the point P0 and a cross point P5 at which the virtual line L crosses a straight line L4 extending in a perpendicular direction with respect to the virtual line L from a cross point P4 at which a straight line L3 connecting the point P0 and the point P1 crosses the outer circumferential surface 114a of the developing sleeve 114) is referred to as d1, a distance between the point P3 and the point P0 is referred to as d2, and a diameter of a carrier is referred to as d3. Also, an angle between the virtual line L and the straight line L3 connecting the point P0 and the point P1 is referred to as θ1, and an angle between the virtual line L and a straight line L5 connecting the point P2 and the point P1 is referred to as θ2. Furthermore, the groove 15 is right-and-left symmetrical with respect to the virtual line L.

The groove 115 of the developing sleeve 114 is formed to satisfy Equations 1, 2, and 3 below.

θ1<θ2 [Equation 1]

d3/3<d1−d2<d3 [Equation 2]

d1>d3×2 [Equation 3]

That is, the edge at which the inner sidewall 115a forming the V-shape of the groove 115 meets the outer circumferential surface 114a of the developing sleeve 114 is removed (Equation 1). By doing so, an initial status of the groove 115 is intentionally similar to a used status so as to achieve long-term stabilization in developer transportability. As described above, an edge part 115b highly contributes to the developer transportability. In a developing sleeve having a V-shaped groove with an edge that is not removed according to the related art, the edge becomes round while being used, as illustrated in FIG. 5, so that a shape of the edge in an initial status is very different from a shape of the edge in a status after a predetermined time period. Thus, in this case, developer transportability of the developing sleeve sharply deteriorates such that the developer transportability is not stable. On the other hand, in the developing sleeve 114 according to the present embodiment, an edge is removed from the beginning, so that a shape of the edge in an initial status is not much different from a shape of the edge in a status after a predetermined time period, thus, developer transportability is stable for a long-time.

By forming the edge part 115b, developer transportability deteriorates, compared to the developer transportability according to the related art. However, although developer transportability by one groove deteriorates, the number of the grooves 115 formed in the outer circumferential surface 114a of the developing sleeve 114 may be increased so that it is possible to form a uniform developer layer. Also, it is possible to arrange a large gap between the thickness regulating member 150 and the developing sleeve 114, so that it is possible to prevent the gap from being filled with foreign substances.

Hereinafter, referring to FIG. 6, with respect to a developing sleeve according to the related art and the developing sleeve 114 according to an embodiment, the relationship between an amount of developer on a developing sleeve and a gap between a developing sleeve and a thickness regulating member is compared. A groove formed in the developing sleeve according to the related art is a V-shaped groove of which an edge is not removed. As illustrated in FIG. 6, when the number of grooves formed in an outer circumferential surface of a developing sleeve is increased, developer transportability is increased. However, when the number of grooves is increased, a gap between the developing sleeve and a thickness regulating member has to be narrowed so as to maintain an amount of developer transported by the developing sleeve to a target amount, such that the narrowed gap may be filled with foreign substances. On the other hand, when the number of grooves is decreased, an interval between adjacent grooves becomes large, such that developer transportability is unstabilized, and thus an image may have one or more spots.

With respect to this problem, by forming a groove of which an edge is removed, as shown in the developing sleeve 114 according to the present embodiment, developer transportability of the developing sleeve 114 deteriorates compared to that of the developing sleeve according to the related art, in a condition where a gap from the thickness regulating member and the number of grooves are the same. However, by increasing the number of grooves 115, the transportability of the developing sleeve 114 may improve and a gap between the developing sleeve 114 and the thickness regulating member 150 may become great. By doing so, it is possible to form a stabilized developer layer.

Next, a height (d1−d2) of the edge part 115b is defined to transportably support a carrier (Equation 2). As illustrated in FIG. 4, a toner T is transported in a magnetic brush status by a carrier C. Here, in order to allow the carrier C to surely transport the toner C by being supported by the edge part 115b, the edge part 115b is formed while satisfying Equation 2.

Next, a depth d1 of the groove 115 is set to a predetermined value (Equation 3). By doing so, as illustrated in FIG. 4, the groove 115 accepts a developer in its V-shaped form and maintains the developer by the inner sidewall 115a. In this manner, the groove 115 may sufficiently maintain and transport the developer.

In the developing sleeve 114 according to the present embodiment, the plurality of the grooves 115 having the V-shape are formed while satisfying at least one or all of the aforementioned three conditions. Furthermore, the shape of the groove 115 is symmetrical with respect to the virtual line L, so that an incorrect assembly may be prevented.

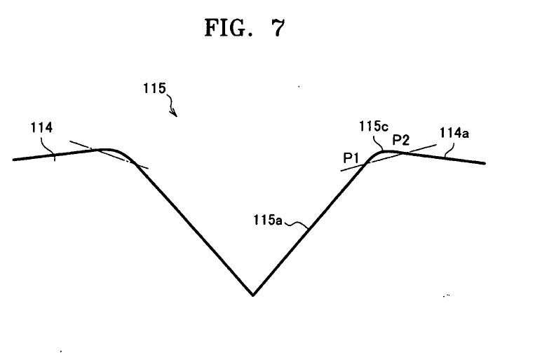

In addition, although the edge part 115b of the groove 115 is flat in FIG. 3, a shape of the edge part 115b is not limited thereto. For example, as illustrated in FIG. 7, an edge part 115c may be formed in a shape of a curved line projecting from a straight line that connects a point P1 and a point P2. Also, an edge part even though not illustrated may be formed in a shape of a curved line gently depressed from the straight line that connects the point P1 and the point P2. In this manner, an edge part of the groove 115 may have a shape similar to a shape that is deformed due to use.

Above, the configuration of the developing sleeve according to the embodiment is described. By using the developing sleeve, it is possible to prevent developer transportability from deteriorating when it is first used, so that long-term stabilization in the developer transportability may be achieved. Also, an interval between adjacent grooves formed in the developing sleeve may be narrowed so that a developer layer may be uniformly formed, and non-uniformity of toner density occurring by a flat portion between grooves may be prevented. Furthermore, a gap between the developing sleeve and the thickness regulating member may be large, so that it is possible to prevent the gap from being filled with foreign substances.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A developer bearing member that carries a developer comprising a carrier and a toner on its outer circumferential surface, and transports the developer,
wherein a plurality of grooves having a V-shape extending in an axial direction are formed on the outer circumferential surface of the developer bearing member, and
wherein an edge at which the outer circumferential surface of the developer bearing member meets an inner sidewall forming each of the plurality of grooves is removed.

2. The developer bearing member of claim 1, wherein, when a lowest point of each of the plurality of grooves is referred to as a point P0, a straight line connecting the point P0 and a rotational center of the developer bearing member is referred to as a virtual line L, a random point on an inner sidewall forming the V-shape of each of the plurality of grooves is referred to as a point P1, a random point on the outer circumferential surface of the developer bearing member is referred to as a point P2, a cross point between the virtual line L and a line extending from the point P1 in a perpendicular direction with respect to the virtual line L is referred to as a point P3, a depth of each of the plurality of grooves is referred to as d1, a distance between the point P3 and the point P0 is referred to as d2, a diameter of a carrier is referred to as d3, an angle between the virtual line L and a straight line connecting the point P0 and the point P1 is referred to as θ1, and an angle between the virtual line L and a straight line connecting the point P2 and the point P1 is referred to as θ2, wherein ‘θ1<θ2’ is satisfied.

3. The developer bearing member of claim 2, wherein ‘d3/3<d1−d2<d3’ is satisfied.

4. The developer bearing member of claim 3, wherein ‘d1>d3×2’ is satisfied.

5. The developer bearing member of claim 4, wherein each of the plurality of grooves is symmetrical with respect to the virtual line L.

6. A developing device comprising:
an agitating and transporting unit containing a developer comprising a carrier and a toner, the agitating and transporting unit comprising agitating and transporting members that mix and agitate the developer, and then transport the developer in a predetermined transporting direction; and
a developer bearing member of claim 1,
wherein the developer bearing member is arranged to face an electrostatic latent image bearing member bearing an electrostatic latent image, carries the developer agitated and mixed by the agitating and transporting unit on its outer circumferential surface, and then transports the developer to the electrostatic latent image bearing member.

7. The developing device of claim 6, wherein, when a lowest point of each of the plurality of grooves is referred to as a point P0, a straight line connecting the point P0 and a rotational center of the developer bearing member is referred to as a virtual line L, a random point on an inner sidewall forming the V-shape of each of the plurality of grooves is referred to as a point P1, a random point on the outer circumferential surface of the developer bearing member is referred to as a point P2, a cross point between the virtual line L and a line extending from the point P1 in a perpendicular direction with respect to the virtual line L is referred to as a point P3, a depth of each of the plurality of grooves is referred to as d1, a distance between the point P3 and the point P0 is referred to as d2, a diameter of a carrier is referred to as d3, an angle between the virtual line L and a straight line connecting the point P0 and the point P1 is referred to as θ1, and an angle between the virtual line L and a straight line connecting the point P2 and the point P1 is referred to as θ2, wherein ‘θ1<θ2’ is satisfied.

8. The developing device of claim 7, wherein ‘d3/3<d1−d2<d3’ is satisfied.

9. The developing device of claim 8, wherein ‘d1>d3×2’ is satisfied.

10. The developing device of claim 9, wherein each of the plurality of grooves is symmetrical with respect to the virtual line L.

11. An image forming apparatus comprising:
an electrostatic latent image bearing member bearing an electrostatic latent image on its outer circumferential surface; and
a developing device of claim 6,
wherein the developing device develops the electrostatic latent image on the electrostatic latent image bearing member.

12. The image forming apparatus of claim 11, wherein, when a lowest point of each of the plurality of grooves is referred to as a point P0, a straight line connecting the point P0 and a rotational center of the developer bearing member is referred to as a virtual line L, a random point on an inner sidewall forming the V-shape of each of the plurality of grooves is referred to as a point P1, a random point on the outer circumferential surface of the developer bearing member is referred to as a point P2, a cross point between the virtual line L and a line extending from the point P1 in a perpendicular direction with respect to the virtual line L is referred to as a point P3, a depth of each of the plurality of grooves is referred to as d1, a distance between the point P3 and the point P0 is referred to as d2, a diameter of a carrier is referred to as d3, an angle between the virtual line L and a straight line connecting the point P0 and the point P1 is referred to as θ1, and an angle between the virtual line L and a straight line connecting the point P2 and the point P1 is referred to as θ2, wherein ‘θ1<θ2’ is satisfied.

13. The image forming apparatus of claim 12, wherein ‘d3/3<d1−d2<d3’ is satisfied.

14. The image forming apparatus of claim 13, wherein ‘d1>d3×2’ is satisfied.

15. The image forming apparatus of claim 14, wherein each of the plurality of grooves is symmetrical with respect to the virtual line L.

16. A developer bearing member that carries a developer comprising a carrier and a toner on its outer circumferential surface, and transports the developer,
wherein a plurality of grooves extending in an axial direction are formed on the outer circumferential surface of the developer bearing member, each of the plurality of grooves having a symmetrical four sided structure.

17. The developer bearing member of claim 16, wherein, in each of the plurality of grooves, a lowest point of each of the plurality of grooves is referred to as a point P0, a straight line connecting the point P0 and a rotational center of the developer bearing member is referred to as a virtual line L, a random point on an inner sidewall forming the groove is referred to as a point P1, a random point on the outer circumferential surface of the developer bearing member is referred to as a point P2, a cross point between the virtual line L and a line extending from the point P1 in a perpendicular direction with respect to the virtual line L is referred to as a point P3, a depth of the groove is referred to as d1, a distance between the point P3 and the point P0 is referred to as d2, a diameter of a carrier is referred to as d3, an angle between the virtual line L and a straight line connecting the point P0 and the point P1 is referred to as θ1, and an angle between the virtual line L and a straight line connecting the point P2 and the point P1 is referred to as θ2, so that the equation θ2<θ2 is satisfied.

18. The developer bearing member of claim 17, wherein the equation d3/3<d1−d d2<d3 is satisfied.

19. The developer bearing member of claim 18, wherein the equation d1>d3×2 is satisfied.

20. The developer bearing member of claim 19, wherein each of the plurality of grooves is symmetrical with respect to the virtual line L.
